(19) United States
(12) Patent Application Publication
(10) Pub. No.: US 2014/0095209 A1
(43) Pub. Date: Apr. 3, 2014

(54) SYSTEM AND METHOD FOR MITIGATING THE RISK OF HEMOLYTIC TRANSFUSION REACTIONS

(71) Applicant: National Patient Antibody Registry, LLC, Ronkonkoma, NY (US)

(72) Inventors: Adam Molny, Ronkonkoma, NY (US); David Molny, Ronkonkoma, NY (US); Janet Molny, Ronkonkoma, NY (US); Claire Iannacone, Ronkonkoma, NY (US)

(73) Assignee: National Patient Antibody Registry, LLC, Ronkonkoma, NY (US)

(21) Appl. No.: 14/043,468

(22) Filed: Oct. 1, 2013

Related U.S. Application Data
(60) Provisional application No. 61/708,397, filed on Oct. 1, 2012.

(51) Int. Cl. G06F 19/00

(52) U.S. Cl. CPC G06F 19/3431
USPC 705/3

(57) ABSTRACT

A data structure for maintaining hemolytic risk histories of a blood recipient is populated by receiving data extracted from a data repository of a blood facility. The data includes information relating to attributes of blood recipients including hemolytic risk data. Recipient profiles are built based upon the information and hemolytic risk histories are created for a recipient from the hemolytic risk data.

### BACKGROUND

Transfusion medicine is a specialized branch of hematology that is concerned with the study of blood groups. Integral to transfusion medicine is the work of blood banks which provide a transfusion and storage service for blood and other blood products. In transfusion medicine, when obtaining a suitable blood product match for a transfusion recipient, the blood of the recipient should be compatible with a blood product's profile, e.g., blood type and Rh factor as well as over two hundred additional characteristics for red blood cells, called antigens.

Frequently-transfused recipients often develop antibodies against some of those antigens, a process known as alloimmunization. These antibodies can destroy the donated red cells, a process known as hemolysis. Hemolytic reactions are a leading complication from blood transfusions. Symptoms may include fever, chills, pain, lowered hemoglobin levels, hypotension, hemoglobinuria, and hyperbilirubinemia. In severe cases, permanent injury or death may result.

In order to avoid hemolytic reactions, blood banks routinely use laboratory tests to cross-check compatibility between donor blood products and a recipient by mixing a sample of the recipient's serum with a sample of the donor's red blood cells and checking if the mixture agglutinates, or forms clumps. If agglutination occurs, that particular donor's blood cannot be transfused to that particular recipient.

As another guard against hemolytic reactions, blood banks also maintain records of each patient's treatment at that facility. If a patient is known to be alloimmunized, blood products containing the corresponding antigen(s) will not be used.

### SUMMARY OF THE DISCLOSED TECHNOLOGY

The disclosed technology relates to a system and method for aggregating and maintaining hemolytic risk histories. The disclosed technology implements a system that automatically extracts blood-recipient information, e.g., hemolytic risk data, from multiple computer systems housed in a blood facility, e.g., blood banks and hospitals. This information is uploaded to a centralized server. The centralized server then builds recipient profiles in which hemolytic risk histories are created from the hemolytic risk data. The profiles are stored in a searchable data structure so that blood facility staff can search for the recipient's profile and review their hemolytic risk history. The hemolytic risk history can be matched to a compatible blood product prior to a transfusion.

In one implementation, a computer-implemented method comprises the steps of: receiving data extracted from at least one data repository of at least one facility, where the data includes information relating to attributes of recipients including hemolytic risk data; building recipient profiles based upon the information where the recipient profiles include an hemolytic risk history; and populating a searchable data structure with the recipient profiles.

The method can also include: searching for at least one recipient profile within the searchable data structure; matching the at least one recipient profile with a blood product wherein a hemolytic risk history for the at least one recipient profile is compatible with a blood product profile of the blood product; and providing at least one blood match to a display. The method can also include: searching for at least one recipient profile within the searchable data structure and transmitting an order for a blood product to at least one blood supplier, the order including a hemolytic risk history for the at least one recipient profile. The method can further include cross-checking compatibility between the hemolytic risk history for the at least one recipient profile with the blood product profile of a blood product in order to reduce risk of hemolytic reactions.

In some implementations, the recipient profiles can include a name, a date of birth, unique identifiers, a primary blood type, an Rh type, a transfusion history, an alloimmunization history, a genotype, and a transfusion reaction history of a recipient. In some implementations, the blood product can be associated with donor information that includes a primary blood type, an Rh type, genotype, age, race, and gender of the donor. In some implementations, the data can be extracted from the at least one data repository of at least one facility on a daily basis.

In another implementation, a system can comprise one or more processors and one or more computer-readable storage mediums containing instructions configured to cause the one or more processors to perform operations. The operations can include: receiving data extracted from at least one data repository of at least one facility, where the data includes information relating to attributes of recipients include hemolytic risk data; building recipient profiles based upon the information where the recipient profiles including a hemolytic risk history; and populating a searchable data structure with the recipient profiles.

In another implementation, a computer-program product can be tangibly embodied in a machine-readable storage medium and include instructions configured to cause a data processing apparatus to: receive data extracted from at least one data repository of at least one facility, where the data includes information relating to attributes of recipients include hemolytic risk data; build recipient profiles based upon the information, where the recipient profiles including an hemolytic risk history; and populate a searchable data structure with the recipient profiles.

The methods, systems and computer-program products compile a blood profile of a recipient including an hemolytic risk history so that if a red cell antibody in the bloodstream of the recipient decreases below detectable levels, the recipient can still be given a compatible blood product regardless of the results of any laboratory testing in which the antibody was not detected.

### BRIEF DESCRIPTION OF THE DRAWINGS

FIG. 1 is a block diagram of an example of a network used with the disclosed technology; and

FIG. 2 is a flow chart showing an example process of finding a recipient within a centralized database.

### DETAILED DESCRIPTION

Transfusion medicine is a specialized branch of hematology that is concerned with the study of blood groups. Integral to transfusion medicine is the work of blood banks which provide a transfusion and storage service for blood and other blood products. The work of a blood bank can involve the testing of blood from both donors and recipients to ensure that every individual recipient is given blood that is compatible and is as safe as possible. If a unit of incompatible blood is transfused between a donor and recipient, a severe acute hemolytic reaction (i.e., red blood cell destruction), renal failure and shock is likely to occur, and death is a possibility. Antibodies can be highly active and can attack red blood cells and bind components of the blood thereby causing massive hemolysis of the transfused blood.

Recipients, in ideal situations, should receive their own blood or, in other cases, a blood product specific to the recipient's blood profile should be used in order to minimize the chance of a transfusion reaction.

Risks can be further reduced by cross-matching blood for compatibility between donor and recipient blood to reduce the risk of hemolytic reactions. Current cross-matching technology involves mixing a sample of the recipient's serum with a sample of the donor's red blood cells and checking if the mixture agglutinates, or forms clumps. If agglutination occurs, that particular donor's blood cannot be transfused to that particular recipient.

However, the number of red cell antibodies in the bloodstream decreases over time, often dropping below detectable levels several years after the patient's last exposure to a given antigen. However, the recipient's immune system retains the ability to rapidly re-create those antibodies if exposed to the problematic antigen(s) at a later time. Thus donor and recipient blood samples that seem fully compatible in the laboratory can still provoke a transfusion reaction.

Blood facilities, e.g., blood banks and hospitals, keep detailed records of all positive tests for red cell antibodies, and a blood facility will generally not issue blood that contains antigens to which a recipient is known to be alloimmunized. This further reduces the likelihood of a transfusion reaction. However, each blood facility has their own record-keeping system, and there is currently little in the way of information-sharing between blood facilities. Thus, a blood facility may be unaware that a given recipient is alloimmunized even though that information may reside in another blood facility's records. Blood facilities can also use a recipient's genotype to further inform blood facilities about patients' risk of a hemolytic reaction. That is, knowledge of a recipient's genotype can help predict future development of red cell antibodies. For example, if a recipient who lacks a Kell antigen gene is repeatedly exposed to Kell-positive blood, the recipient is likely to develop anti-Kell antibodies. Accordingly, blood facilities can classify blood products as, e.g., Kell-negative or Kell-positive, and not issue blood that contains certain genotypes to which a recipient does not have the antigen thereby reducing the likelihood of a transfusion reaction.

The disclosed technology implements a computer system that automatically uploads recipient information from each blood facility's computer system(s) to a centralized server. The centralized server can build and update recipient profiles so as to create a blood profile with a hemolytic risk history, e.g., an alloimmunization history or a genotype history. Once formed, blood facility staff can search the server for the recipient's profile prior to issuing blood products for transfusion. Ideally such a registry would cover a large geographic area, e.g., the entire United States, so that recipient profiles are available regardless of domestic travel or relocation.

In accordance with the U.S. Health Insurance Portability and Accountability Act of 1996 (HIPAA), the data extracted should be the minimum set required for the treatment purpose at hand. For the purpose of reducing the risk of transfusion reactions, the data set for the recipient's profile can include demographic information required in order to locate a recipient's profiles, e.g., name, date of birth, sex, primary blood type (A, B, AB, or O), Rh (positive or negative), genotype, unique identifiers, transfusion history, any history of positive red cell antibody tests, known alloimmunizations, or any other history of transfusion reactions. Unique identifiers may include, but are not limited to, Social Security number, a driver's license number, a Regional Health Network patient number, an insurance policy number, or a military identification number.

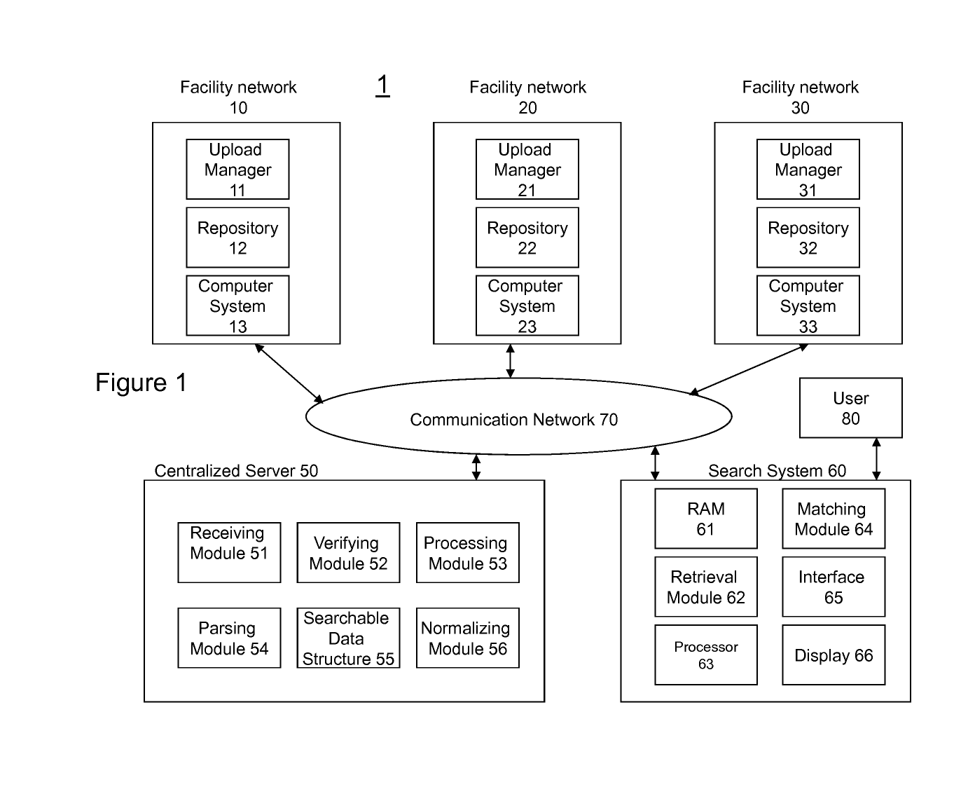

FIG. 1 illustrates a block diagram of an example of a blood-recipient network 1. In one implementation, upload managers 11, 21, 31 can be installed on a blood facility's computer network 10, 20, 30 and the centralized server 50 can reside in a secured facility and be in communication with a search system 60. The upload managers 11, 21, 31, centralized server 50 and search system 60 can be connected through a communication network 70. The communication network 70 facilitates communication between the various components of the network. In some implementations, the communication network 70 can include the Internet, one or more intranets, and/or one or more bus subsystems. The communication network 70 can optionally utilize one or more standard communications technologies, protocols, and/or inter-process communication techniques.

The upload managers 11, 21, 31 extract data from each blood facility's computer system 13, 23, 33. That is, the upload managers 11, 21, 31 extract recipient information from a repository 12, 22, 32 associated with each blood facility's computer system 13, 23, 33, e.g., a name, a date of birth, unique identifiers, a primary blood type, an Rh type, genotype, alloimmunization history, a transfusion history, transfusion reaction history and combinations thereof. In some implementations, each repository 12, 22, 32 of each blood facility's computer system 13, 23, 33 can have a unique data structure designed specifically for that system. In some implementations, a blood facility 10, 20, 30 can be part of group of facilities, such as a hospital chain that has a shared data structure.

In either case, the upload managers 11, 21, 31 can be configured to support a single facility or a facility chain. That is, the upload managers 11, 21, 31 can be configured so that data contained on the facility computer system can be conformed into an integrated format compatible with the centralized server 50. In other words, the upload managers 11, 21, 31 can extract data from each repository of each facility computer system and transform the data into a format suitable for the centralized server 50, e.g., the data can be formatted in accordance with an XML schema. This transformation can be performed by an extraction algorithm that transforms the data from the facility computer system into a transferable data file. Once transformed, the upload manager can send a full data set or only those values that changed since a previous transmission, known as a “differential” upload, to the centralized server. These differential uploads allow the server 50 to process data more quickly than full uploads, and the differential uploads consume less network bandwidth when transmitted from the upload manager 11, 21, 31 to the server 50.

In addition, any other logical transformations, unifying of data elements, and data cleansing can be performed during this process, e.g., normalizing any known malformed data or standardizing patient codes. The International Society of Blood Transfusion (ISBT) defines a standard code for each type of antibody. Many patient records held within a blood facility, however, often predate the ISBT standard, and therefore contain non-standard antibody codes. Antibody code mapping can be utilized to allow matching between a blood facility's non-standard codes with the standardized ISBT codes. This mapping relieves end users of the burden of interpreting non-standard codes, and helps ensure clear communication of antibody history between facilities. In some implementations, the upload managers 11, 21, 31 can extract the data from the repository 12, 22, 32 of the blood facility's computer system 13, 23, 33, hash-encrypt any highly confidential information, e.g., any unique identifiers, format the data in accordance with an XML schema, compress and encrypt the XML output, and transmit a data file to the server 50.

The server 50 receives, verifies and processes the transmitted data file through receiving module 51, verifying module 52 and processing module 53. In some implementations, once the server 50 receives the data file, the data file can be parsed by parsing module 54 into recipient profiles. The parsed profiles can contain multiple attributes e.g., a name, a date of birth, unique identifiers, a primary blood type, an Rh type, genotype, alloimmunization history, a transfusion history, transfusion reaction history and any other information that can be used to identify or treat a recipient. The server 50 can audit and verify the attributes contained within the profiles to ensure all the data within the profile is maintained in a consistent format. To maintain a consistent format in the database the profiles can be mapped to a unique identifier. The identifier may be automatically chosen by the system or may be manually input. Once the data is parsed into a profile, the data within the profile can be normalized by a normalizing module 56. For example, some blood facility databases can contain inaccuracies and variations with respect to a recipient, particularly, with respect to the spelling of a recipient or donor's name, e.g., typos, sound-alike spellings (such as, GONZALES vs. GONZALEZ), differences in capitalization, hyphenation, titles (such as, REV. or DR.), or suffixes (such as, JR., PHD, MD, etc.). To normalize these variations, the server can (1) convert all letters in a recipient's name to upper case, (2) remove apostrophes from the name, e.g., O'NEAL becomes ONEAL, 3. convert any zeros in a name to the letter “O”, (4) replace any non-alphabetic characters with blanks, (5) ignore variants of SAINT, e.g., ST., STE., SANTA, etc., (6) merge prefixes with the following element, e.g. DE LEON becomes DELEON, (7) discard any suffixes, or (8) index each part of a multi-part names separately, e.g., SMITH-JONES can be stored in fields with different variations—SMITH, JONES and SMITH JONES.

Once normalized, in some implementations, the profile can be encrypted and stored as a new profile in the searchable data structure 55. In another implementation, the profiles can be matched with existing profiles in order to update a recipient profile already within the searchable data structure 55. The matching can be performed by comparing attributes of the new profile with attributes of existing profiles and if the attributes can be matched above a certain threshold, e.g. profiles are a 90% match, the profiles can be combined.

Once the profiles are processed, the profiles are stored within the searchable data structure 55. A set of profiles can be marked as ‘active’ in the searchable data structure 55. The searchable data structure 55 can also mark previous sets of profiles as ‘inactive’ so that administrators have the ability to revert to a previous data set in the event that problems are detected. For each processed profile, the server 50 can generate a report indicating the outcome of the processing run, along with “exception” information about any records that are deemed to be erroneous or questionable within the profile, e.g., a transfusion dated one year before the recipient's birth date.

The search system 60 works in conjunction with the server. That is, the search system 60 is an example of a retrieval system using a retrieval module 62. The search system 60 can be used, for example, to locate a recipient and review her blood profile with a hemolytic risk history. A user 80 can interact with server 50 through interface 65. For example, the search system 60 can be a computer coupled to the server 50 through a local area network (LAN) or wide area network (WAN), e.g., the Internet. In some implementations, the server 50 and the search system 60 can be one machine. The search system 60 will generally include a random access memory (RAM) 61 and a processor 63.

In one example, a user queries the search system 60 to locate a recipient profile. Each query can begin by entering search criteria, e.g., a recipient's last name and date of birth, and optionally the first and middle names, unique identifiers, sex, blood type and Rh type. The search system estimates the number of potential matches based on statistical probabilities and can warn the user 80 if the size of the anticipated result set exceeds preset thresholds. The user 80 may then refine their query to return fewer results.

In some implementations, when a user 80 initiates a recipient search, the search system 60 can combine a phonetic algorithm with so-called fuzzy match algorithms to identify recipients whose normalized last names are close to the search parameters and whose dates of birth match the search parameters, e.g., dates of birth in which the month and day are reversed (e.g. 07/04/1976 vs. 04/07/1976) can be treated as a potential match during the recipient search.

The set of possible matches is then filtered by blood type, Rh type, and sex, if those elements are specified in the search parameters. Finally, potential matches are ranked based on how closely they match the search parameters. The search system 60 displays the matching records' demographic information to the user on a display. The user 80 may opt to alter the search parameters or select individual records to review in detail. Those details include each recipient's hemolytic risk history that can include past transfusions, past transfusion reactions, genotypes and antibodies. The search system 60 may also provide an antibody code and the code can be matched to an ISBT-standard code so that the standard code is displayed to the user. The code can also be hyperlinked to a page that contains clinical information about the antibody from recognized industry sources. This lets the user quickly refresh her memory about the characteristics of less-common antibodies. In some implementations, the recipient profile can be updated by the user to include any new information obtained by the blood facility associated with the user, e.g., results of any testing performed by the blood facility associated with the user.

Under HIPAA, a recipient can refuse permission for the retrieval of their records from other treatment facilities. In some implementations, an interface can be utilized to record any recipients that have withheld consent (i.e., “opted out”.) When a user 80 performs a search, the server 50 flags any opt-out records that match the search parameters. If a match is found, the server displays a warning message to the user and requires them to either abandon the search or certify that they are overriding the warning due to a life-threatening situation. All overrides are logged within the system.

Once a recipient is found in the server 50, a blood match can be performed using the recipient's blood profile, including the hemolytic risk history. That is, after the user 80 has identified a recipient, the server can pass the list of all previously known antibodies and genotypes to a blood product inventory system of a blood facility 10, 20, 30. In some implementations, the blood facilities 10, 20, 30 can interface to the centralized server through the communications network so that patient genotype, antibody, alloimmunization or hemolytic risk history can be viewed on each blood facility's own computer system. This allows a blood facility 10, 20, 30 to quickly determine if appropriate antigen-negative blood products are available. Once a blood facility 10, 20, 30 processes a blood order, if the user 80 has doubts or questions about the blood order, e.g., information related to a blood profile report of a specific blood product, the user 80 can issue a confirmation request to the blood facility 10, 20, 30 that supplied that information. In return, the blood facility can send a free-form message to the user 80 confirming that the information related to the blood product is accurate or indicate that they have corrected or updated the information

In some implementations, the upload manager 11, 21, 31 can also upload blood product profiles to an inventory database within the centralized server 50. The blood product profile can be associated with donor information that includes a primary blood type, an Rh type, age, race, gender, an antigen report, and genotype. The blood product profile can list all antigens or genotypes contained within the blood product. After a recipient has been located within the database, the recipient can be matched with a blood product. Specifically, the hemolytic risk history of the recipient profile can be matched with blood product profile of a blood product. This blood match is provided to a search system and displayed on display 66 to a user for ordering purposes. In some implementations, the interface 65 can transmit an order for blood products to a blood supplier, e.g., another blood facility.

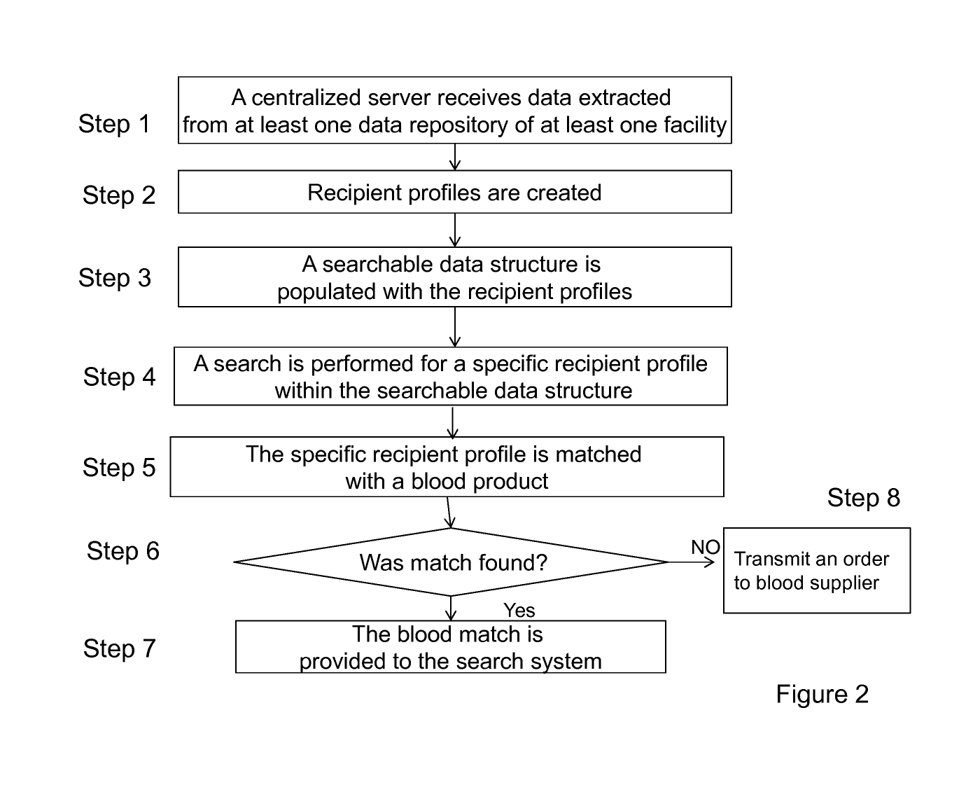

FIG. 2 shows a flow chart for finding a recipient within a centralized database. The centralized server 50 receives data extracted from a repository 12, 22, 32 of a facility 10, 20, 30. (Step 1). The data can include information relating to attributes of recipients including hemolytic risk data. Recipient profiles are created based upon the information. (Step 2). The recipient profiles can include a name, a date of birth, unique identifiers, a primary blood type, an Rh type, genotype, a transfusion history, transfusion reaction history, an alloimmunization history, and a hemolytic risk history. Once the profiles are created, a searchable data structure 55 is populated with the recipient profiles. (Step 3). A user 80 can search for recipient profiles within the searchable data structure 55 using a search system 60 connected to the centralized server 50. (Step 4). Once a recipient profile is found, the profile can be matched with a blood product wherein a hemolytic risk history of the recipient profile is compatible with a blood product profile of the blood product. (Step 5). If a blood match is found (Step 6), this blood match can be provided to a display of the search system 60. (Step 7). If a blood match is not found (Step 6), e.g., no suitable blood products are available in a facility's inventory, the interface 65 can transmit an order for a suitable blood product to a blood supplier, e.g., another blood facility. (Step 8).

It is noted that the systems and methods disclosed herein may be implemented on various types of computer architectures, such as for example on a single general purpose computer or workstation, or on a network (e.g., local area network, wide area network, or internet), or in a client-server configuration, or in an application service provider configuration. Also, the system's and method's data may be stored as one or more data structures in computer memory and/or storage depending upon the application at hand. The systems and methods may be provided on many different types of computer readable media including instructions being executable by a computer to perform the system and method operations described herein. The systems and methods may also have their information transmitted via data signals embodied on carrier signals (e.g., radio frequency carrier signals) or other communication pathways (e.g., fiber optics, infrared, etc.).

The computer components, software modules, functions and data structures described herein may be connected directly or indirectly to each other in order to allow the flow of data needed for their operations. It is also noted that a module includes but is not limited to a unit of code that performs a software operation, and can be implemented for example as a subroutine unit of code, or as a software function unit of code, or as an object (as in an object-oriented paradigm), or as an applet, or in a computer script language, or as another type of computer code. The computer components may be located on a single computer or distributed across multiple computers depending upon the situation at hand.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

1. A computer-implemented method comprising the steps of:
receiving data extracted from at least one data repository of at least one facility, the data including information relating to attributes of recipients including hemolytic risk data;
building recipient profiles based upon the information, the recipient profiles including a hemolytic risk history; and
populating a searchable data structure with the recipient profiles.

2. The method of claim 1 further comprising the steps of:
searching for at least one recipient profile within the searchable data structure;
matching the at least one recipient profile with a blood product wherein a hemolytic risk history for the at least one recipient profile is compatible with a blood product profile of the blood product; and
providing at least one blood match to a display.

3. The method of claim 1 further comprising the steps of:
searching for at least one recipient profile within the searchable data structure; and
transmitting an order for a blood product to at least one blood supplier, the order including a hemolytic risk history for the at least one recipient profile.

4. The method of claim 1 wherein the recipient profiles further includes a name, a date of birth, unique identifiers, a primary blood type, an Rh type, genotypes, a transfusion history, a transfusion reaction history, an alloimmunization history and combinations thereof.

5. The method of claim 1 wherein the blood product is associated with donor information that includes a primary blood type, an Rh type, genotypes, age, race, gender and combinations thereof.

6. The method of claim 2 wherein the matching step cross-checks compatibility between the hemolytic risk history for the at least one recipient profile with the blood product profile of a blood product in order to reduce risk of hemolytic reactions.

7. The method of claim 1 wherein the data is extracted from the at least one data repository of at least one facility on a daily basis.

8. A system comprising:
one or more processors;
one or more computer-readable storage mediums containing instructions configured to cause the one or more processors to perform operations including:
receiving data extracted from at least one data repository of at least one facility, the data includes information relating to attributes of recipients including hemolytic risk data;
building recipient profiles based upon the information, the recipient profiles including a hemolytic risk history; and
populating a searchable data structure with the recipient profiles.

9. The system of claim 8 further comprising the steps of:
searching for at least one recipient profile within the searchable data structure;
matching the at least one recipient profile with a blood product wherein an hemolytic risk history for the at least one recipient profile is compatible with a blood product profile of the blood product; and
providing at least one blood match to a display.

10. The system of claim 8 further comprising the steps of:
searching for at least one recipient profile within the searchable data structure; and
transmitting an order for a blood product to at least one blood supplier, the order including a hemolytic risk history or the at least one recipient profile.

11. The system of claim 8 wherein the recipient profiles further includes a name, a date of birth, unique identifiers, a primary blood type, an Rh type, genotypes, a transfusion history, a transfusion reaction history, an alloimmunization history and combinations thereof.

12. The system of claim 8 wherein the blood product includes a primary blood type, an Rh type, genotypes, age, race, gender and combinations thereof.

13. The system of claim 9 wherein the matching step cross-checks compatibility between the hemolytic risk history for the at least one recipient profile with the blood product profile of a blood product in order to reduce risk of hemolytic reactions.

14. The system of claim 8 wherein the data is extracted from the at least one data repository of at least one facility on a daily basis.

15. A computer-program product, the product tangibly embodied in a machine-readable storage medium, including instructions configured to cause a data processing apparatus to:
receive data extracted from at least one data repository of at least one facility, the data including information relating to attributes of recipients including hemolytic risk data;
build recipient profiles based upon the information, the recipient profiles including an hemolytic risk history; and
populate a searchable data structure with the recipient profiles.

16. The computer-program product of claim 15 further including instructions configured to cause a data processing apparatus to:
search for at least one recipient profile within the searchable data structure;
match the at least one recipient profile with a blood product wherein an hemolytic risk history for the at least one recipient profile is compatible with a blood product profile of the blood product; and
provide at least one blood match to a display.

17. The computer-program product of claim 15 further including instructions configured to cause a data processing apparatus to:
search for at least one recipient profile within the searchable data structure; and
transmit an order for a blood product to at least one blood supplier, the order including a hemolytic risk history for the at least one recipient profile.

18. The computer-program product of claim 15 wherein the recipient profiles further includes a name, a date of birth, unique identifiers, a primary blood type, an Rh type, genotypes, a transfusion history, a transfusion reaction history, an alloimmunization history and combinations thereof.

19. The computer-program product of claim 15 wherein the blood product includes a primary blood type, an Rh type, genotypes, age, race, gender and combinations thereof.

20. The computer-program product of claim 16 the matching step cross-checks compatibility between the hemolytic risk history for the at least one recipient profile with the blood product profile of a blood product in order to reduce risk of hemolytic reactions.
